(19) United States
(12) Patent Application Publication
(10) Pub. No.: US 2006/0187088 A1
(43) Pub. Date: Aug. 24, 2006

(54) School Bus Alert

(76) Inventor: Thanh Van Nguyen, Harvest, AL (US)

Correspondence Address: Thanh Nguyen, 209 ColdSprings Dr., Harvest, AL, 35749, US

(21) Appl. No.: 10/906,334

(22) Filed: Feb. 15, 2005

(51) Int. Cl. G08G 1/123

(52) U.S. Cl. 340/994

(57) ABSTRACT

This system will let students wait safely inside their house and alert the students only when the school bus is actually coming and give the student enough time to walk to the waiting location.

The system consists of a Mobile Unit (MU) which is a transmitter affixed on a school bus. This transmitter can radiate a unique signal to a set miles radius.

All receivers to which they wish to receive this unique signal are set to match the frequency of the transmitter. The sensitivity of each individual receiver can also be calibrated to match the distance needed between the transmitter and receiver. All receivers are Home Based units (HBU).

What is claimed is:

1. This system will help students taking the school bus to eliminate the waiting time at the waiting location.

2. In the past, students have no idea when or will the school bus be coming. This unknown factor create many inconveniences to students and their parents, including: get sick due to waiting too long in harsh weather, school bus never show up (break down), any accident could happen while students waiting for the school bus, including, but not limited to abductions, kidnaps, fightings, . . .
